(19) United States
(12) Patent Application Publication
(10) Pub. No.: US 2010/0194054 A1
(43) Pub. Date: Aug. 5, 2010

(54) SEALING DEVICE

(75) Inventor: Takayuki Nishigaki, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/667,190

(22) PCT Filed: Apr. 6, 2009
(86) PCT No.: PCT/JP2009/057047

§ 371 Date: Dec. 29, 2009

(30) Foreign Application Priority Data
Apr. 8, 2008 (JP) 2008-100189

(51) Int. Cl. F16J 15/32

(52) U.S. Cl. 277/549

(57) ABSTRACT

A sealing device having a dust filter, in which sliding torque due to the dust filter is reduced with dust sealing performance of the dust filter maintained at a high level. The sealing device is provided with a seal lip (12) mounted to a non-rotating housing (200) and made to be in slidable close contact with a rotation-side member (2), and the sealing device is also provided with the dust filter (16) located closer to the atmosphere (A) than the seal lip (12) and having an inner diameter section (16a) which is made to be in slidable close contact with the outer peripheral surface of the rotation-side member (2). Cutouts (16b) are formed at predetermined circumferential intervals in the inner diameter section (16a) of the dust filter (16), and the deepest sections of the cutouts (16b) have an appropriate allowance for fastening to the outer peripheral surface of the rotation-side member (2).

### CROSS-REFERENCE TO RELATED APPLICATIONS

This is a national stage of the International Application No. PCT/JP2009/057047 filed on Apr. 6, 2009 and published in Japanese language.

### BACKGROUND OF THE INVENTION

1. Field of the Invention

The present invention relates to a sealing device sealing an outer periphery of a rotating body, and more particularly to a sealing device provided with a dust filter at an atmosphere side.

2. Description of the Conventional Art

In a sealing device used as an engine seal of a motor truck or the like, a structure having a dust filter is used (refer, for example, to the following patent document).

### Prior Technical Publication

### Patent Publication

Reference is made to Japanese Unexamined Utility Model Publication No. 5-90046, Japanese Utility Model Publication No. 8-3757, and Japanese Unexamined Utility Model Publication No. 5-14739.

FIG. 5 is a half cross sectional view in an installed state showing this kind of conventional sealing device by being cut along a plane passing through an axis. A sealing device 100 shown in FIG. 5 is provided with a seal main body 110 attached to a housing 200, and a metal slinger 120 attached to a rotating shaft 300 inserted to an inner periphery of the housing 200. The seal main body 110 is provided with a metal attaching ring 111 which is pressure inserted and fitted to an inner peripheral surface of the housing 200, a seal lip 112 integrally formed by a rubber material or a material having a rubber-like elasticity in the attaching ring 111 and being slidably brought into close contact with a flange 121 of the slinger 120, and a dust filter 113 provided closer to an atmosphere A side than the seal lip 112,and having an inner diameter section which is slidably brought into close contact with an outer peripheral portion of the sleeve 122 of the slinger 120 in a state of being bent to the atmosphere A side, and made of a non-woven fabric of a synthetic resin fiber.

The seal lip 112 is structured such that its leading end is brought into close contact with the flange 121 of the slinger 120, thereby preventing a sealed subject oil close to a sealed space B side from leaking to the atmosphere A side, and since the slinger 120 has a function of throwing off such a fluid that comes into contact with the flange 121 to an outer peripheral side on the basis of a centrifugal force, it achieves an excellent sealing function against the sealed subject oil which is going to pass through a sliding portion S with the seal lip 112 to an inner peripheral side. Further, the dust filter 113 is structured such as to inhibit the dust from making an intrusion into an inner peripheral space C of the seal lip 112 which comes to a low pressure on the basis of the throwing-off function mentioned above from the atmosphere A side.

In this case, in recent years, in the light of regulation of fuel consumption of a motor vehicle, a further reduction of a sliding torque is required in this kind of sealing device 100. Further, in the sliding torque generated in this kind of sealing device 100, about one third to one half is caused by a sliding motion between the dust filter 113 and the sleeve 122 of the slinger 120. Accordingly, in order to reduce the sliding torque, it is considered to employ a structure having no dust filter 113, or having the dust filter 113 with a reduced thickness to make a tension force applied to the sleeve 122 smaller.

However, in the case that the dust filter 113 is not employed or made thin, the dust coming close to the atmosphere A side makes an intrusion into the inner peripheral space C of the seal lip 112 coming to the low pressure on the basis of the throwing-off function of the flange 121 so as to be bitten into a sliding portion S between the seal lip 112 and the flange 121 of the slinger 120, thereby causing a reduction of a durability of the seal lip 112. Alternatively, there is another risk that the dust makes an intrusion into the sealed space B from the inner peripheral space C of the seal lip 112 on the basis of the throwing-off function of the flange 121 of the slinger 120.

Further, the sealing device 100 shown in FIG. 5 is structured such that a protrusion 123 formed at an end portion opposite to the flange 121 in the sleeve 122 can engage with an inner diameter section of the dust filter 113, in a state in which the sealing device 100 is not installed to the housing 200 and the rotating shaft 300, whereby it is possible to temporarily assemble the slinger 120 with respect to the seal main body 110 in a come-off preventing state, however, if the dust filter 113 is not employed or is formed thin, there is pointed out such a problem that the temporary assembly mentioned above can not be achieved.

### SUMMARY OF THE INVENTION

### Problem to be Solved by the Invention

The present invention is made by taking the points mentioned above into consideration, and a technical object of the present invention is to reduce a sliding torque caused by a dust filter in a state in which a dust sealing property generated by the dust filter is secured, in a sealing device provided with the dust filter.

### Means for Solving the Problem

In order to effectively achieve the technical object mentioned above, in accordance with a first aspect of the present invention, there is provided a sealing device comprising:

a seal lip attached to a non-rotating housing and slidably brought into close contact with a rotation-side member; and
a dust filter located closer to an atmosphere side than the seal lip and having an inner diameter section slidably brought into close contact with an outer peripheral surface of the rotation-side member,

wherein a plurality of cutouts are formed at a predetermined circumferential interval in the inner diameter section of the dust filter, and an edge portion of a deepest section in each of the cutouts has a suitable fastening margin with respect to the outer peripheral surface of the rotation-side member.

In accordance with the structure mentioned above, since a plurality of cutouts are formed at the predetermined circumferential interval in the inner diameter section of the dust filter, a tension force of the dust filter with respect to the outer peripheral surface of the rotation-side member is reduced, and a sliding area of the dust filter with respect to the outer peripheral surface of the rotation-side member becomes smaller due to the provision of the cutouts. Accordingly, a sliding torque is lowered. Further, since the edge portion of the deepest section in each of the cutouts has the suitable fastening margin with respect to the outer peripheral surface of the rotation-side member, a gap is not generated by the cutouts with respect to the outer peripheral surface of the rotation-side member, and the dust filter is not made thin. Accordingly, a desired dust sealing performance can be secured.

Further, in accordance with a second aspect of the present invention, there is provided a sealing device comprising:

a seal lip attached to a non-rotating housing and slidably brought into close contact with a rotation-side member; and

a dust filter located closer to an atmosphere side than the seal lip and having an inner diameter section slidably brought into close contact with an outer peripheral surface of the rotation-side member,

wherein a plurality of slits are formed at a predetermined circumferential interval in the inner diameter section of the dust filter, and an edge portion of a deepest section in each of the slits has a suitable fastening margin with respect to the outer peripheral surface of the rotation-side member.

In accordance with this structure, since a plurality of slits are formed at the predetermined circumferential interval in the inner diameter section of the dust filter, a tension force of the dust filter with respect to the outer peripheral surface of the rotation-side member is reduced. Accordingly, a sliding torque is lowered. Further, since the edge portion of the deepest section in each of the slits has a suitable fastening margin with respect to the outer peripheral surface of the rotation-side member, a gap is not generated by the slits with respect to the outer peripheral surface of the rotation-side member, and the dust filter is not made thin. Accordingly, a desired dust sealing performance can be secured.

### Effect of the Invention

In accordance with the sealing device on the basis of the present invention, since the dust sealing performance obtained by the dust filter can be secured, it is possible to reduce the sliding torque generated by the dust filter without sacrificing a sealing durability.

### BRIEF EXPLANATION OF DRAWINGS

FIG. 1 is a half cross sectional view in an installed state showing a sealing device in accordance with a first embodiment of the present invention by being cut along a plane passing through an axis;

FIG. 2 is a half cross sectional view in an uninstalled state showing the sealing device in FIG. 1 by being cut along the plane passing through the axis;

FIG. 3 is a view of a dust filter used in the sealing device in FIG. 1 as seen from an extending direction of the axis;

FIG. 4 is a half cross sectional view in an installed state showing a sealing device in accordance with a second embodiment of the present invention by being cut along a plane passing through an axis; and

FIG. 5 is a half cross sectional view in an installed state showing a sealing device in accordance with a prior art by being cut along a plane passing through an axis.

### DETAILED DESCRIPTION OF PREFERRED EMBODIMENT

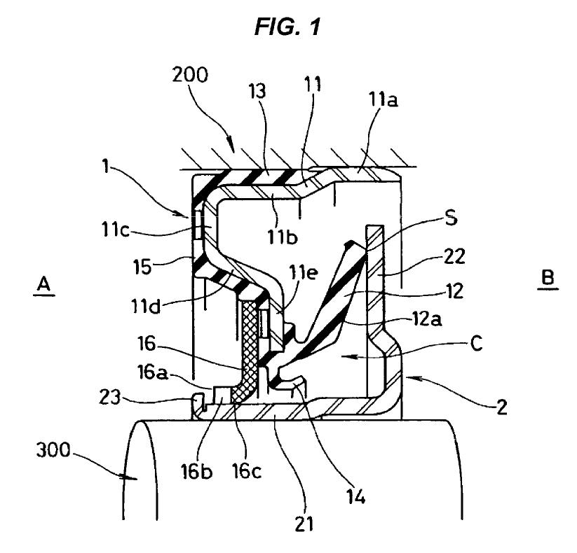

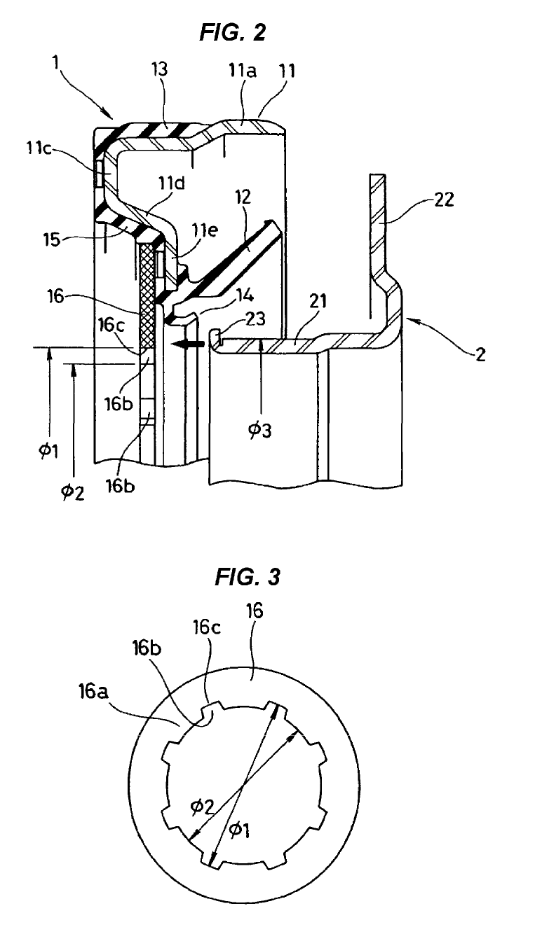

A description will be in detail given below of a preferable embodiment of a sealing device in accordance with the present invention with reference to the accompanying drawings. FIG. 1 is a half cross sectional view in an installed state showing a sealing device in accordance with a first embodiment of the present invention by being cut along a plane passing through an axis, FIG. 2 is a half cross sectional view in an uninstalled state showing the sealing device in FIG. 1 by being cut along the plane passing through the axis, and FIG. 3 is a view of a dust filter used in the sealing device in FIG. 1 as seen from an extending direction of the axis.

In FIG. 1, reference numeral 200 denotes a non-rotating housing in an engine or the like of a motor truck, and reference numeral 300 denotes a rotating shaft inserted to an inner periphery of the housing 200. The sealing device in accordance with the present invention is provided with a seal main body 1 attached to the housing 200, and a slinger 2 attached to the rotating shaft 300. In this case, the slinger 2 corresponds to a rotation-side member described in the first aspect of the invention.

The seal main body 1 is provided with an installation ring 11 which is pressure inserted and fitted to an inner peripheral surface of the housing 200, a seal lip 12, a gasket portion 13, an oil return portion 14 and an elastic layer 15 extending continuously therebetween which are integrally formed in the installation ring 11, and a dust filter 16 which is positioned closer to an atmosphere A side than the seal lip 12 and is attached to an inner diameter section of the elastic layer 15.

The installation ring 11 is manufactured by punching press working a metal plate such as a steel plate or the like, and is constructed by an outer peripheral fitting portion 11a which is pressure inserted and fitted to an inner peripheral surface of the housing 200, a gasket support portion 11b which is formed with a step having a slightly smaller diameter in a direction coming to the atmosphere A side from the outer peripheral fitting portion 11a, a radially extending portion 11c which extends to an inner peripheral side therefrom, a conical tubular portion 11d which extends to a sealed space B side from an inner periphery thereof, and an inward collar portion 11e which further extends to an inner peripheral side from an end portion thereof.

The seal lip 12, the gasket portion 13, the oil return portion 14 and the elastic layer 15 are made of a rubber material or a synthetic resin material having a rubber-like elasticity. Among them, the elastic layer 15 is integrally vulcanized and bonded in such a manner as to coat an outer surface (a surface directed to atmosphere A side) of the installation ring 11, and the seal lip 12 is formed in a tapered shape that its leading end is directed to an outer peripheral side so as to extend to the sealed space B side, from an inner diameter section of the elastic layer 15. Further, the gasket portion 13 is positioned in an outer periphery of the gasket support portion 11b of the installation ring 11, and is continuously formed with an outer diameter section of the elastic layer 15. Further, the oil return portion 14 is formed in an inner diameter section of the elastic layer 15, and is formed in a gutter shape that its leading end is directed to the seal lip 12 side.

The dust filter 16 is made by a non-woven fabric of a synthetic resin fiber, and an outer diameter section thereof is located closer to atmosphere A side than the seal lip 12, i.e. located at an outer side of the inward collar portion 11e of the installation ring 11 so as to be bonded to the elastic layer 15.

The slinger 2 is manufactured by punching press working a metal plate, and has a sleeve 21 which is closely fitted to an outer peripheral surface of the rotating shaft 300, a flange 22 which expands in a disc shape from an end portion close to the sealed space B side, and a protrusion 23 formed at an end portion close to the atmosphere A side in the sleeve 21 so as to be bent to an outer diameter side. The seal lip 12 of the seal main body 1 is slidably brought into close contact in its leading end and its vicinity with an end surface directed to an opposite side to the sealed space B side of the flange 22 in the slinger 2 so as to form a sliding portion S, and the dust filter 16 is structured such that an inner diameter section 16a is slidably brought into close contact with an outer peripheral surface of the sleeve 21 in the slinger 2.

A plurality of cutouts 16b are formed at a predetermined circumferential interval in the inner diameter section 16a of the dust filter 16. Further, the dust filter 16 forms a plane which is orthogonal to an axis in an uninstalled state shown in FIGS. 2 and 3, and in this state, an inner diameter φ1 of a deepest section in each of the cutouts 16b is larger than an inner diameter φ2 of the dust filter 16 and is slightly smaller than an outer diameter φ3 of the sliding portion with the dust filter 16 in the sleeve 21 of the slinger 2. Further, an outer diameter of the protrusion 23 formed at an end portion of the sleeve 21 of the slinger 2 is set to such an extent that can pass through while suitably pushing open the inner diameter section 16a of the dust filter 16, at a time of inserting the slinger 2 as shown by an arrow of the bold line in FIG. 2.

Accordingly, by inserting the sleeve 21 of the slinger 2 to the inner periphery of the seal main body 1 from a separated state shown in FIG. 2, the inner diameter section 16a of the dust filter 16 is brought into close contact with the outer peripheral surface of the sleeve 21 in a state of being suitably pushed open, and the edge portion 16c of the deepest section in each of the cutouts 16b is brought into close contact with the outer peripheral surface of the sleeve 21 with a suitable fastening margin, as shown in FIG. 1.

The sealing device provided with the above mentioned structure is configured, as shown in FIG. 1, such that the seal main body 1 is pressure inserted and fitted to the inner peripheral surface of the housing 200 in the outer peripheral fitting portion 11 a of the installation ring 11, and is closely fitted with the suitable collapsing margin in the gasket portion 13, and the seal lip 12 of the seal main body 1 comes into slidably close contact with the flange 22 of the slinger 2 which is integrally rotated with the rotating shaft 300, thereby inhibiting a sealed subject oil flying from the sealed space (for example, a crank chamber of an engine) B side from leaking to the atmosphere A side. Further, since the slinger 2 has an effect of throwing off a fluid coming into contact with the flange 22 to an outer diameter direction on the basis of a centrifugal force, it achieves an excellent sealing function with respect to the sealed subject oil which is going to pass through the sliding portion S with respect to the seal lip 12 to an inner peripheral side.

Further, in case that the sealed subject oil slightly passes through the sliding portion S between the seal lip 12 and the flange 22 of the slinger 2 to the inner peripheral side, the leaking fluid flows downward along the tapered surface 12a and is received by the gutter-shaped oil return portion 14, in an upper half portion side of the seal lip 12. Further, since the leaking fluid flows within the oil return portion 14 toward its lower half portion side, and runs down to an outer diameter side (a downward side) of the seal lip 12 along the surface 12a in the lower half portion of the seal lip 12, it is thrown off to the outer diameter side from the sliding portion S with respect to the flange 22 on the basis of a centrifugal force so as to be excluded.

In this case, as mentioned above, since the flange 22 of the slinger 2 has the effect of discharging the fluid from the sliding portion S to the outer diameter side on the basis of the centrifugal force at a time of rotating, a negative pressure is generated in the inner peripheral space C of the seal lip 12, whereby the dust is going to flow into the inner peripheral space C together with the air from the atmosphere A side, however, since the dust is captured by the dust filter 16 made by the non-woven fabric of the synthetic fiber, it is possible to inhibit the dust from making an intrusion into the inner peripheral space C.

Further, in the inner diameter section 16a of the dust filter 16, since a plurality of cutouts 16b are formed at a predetermined circumferential interval, a tension force with respect to the outer peripheral surface of the sleeve 21 of the slinger 2 is held down. Further, the sliding area of the dust filter 16 with respect to the outer peripheral surface of the sleeve 21 becomes smaller by the cutouts 16b. Accordingly, since the sliding torque of the dust filter 16 is lowered, and the sliding torque as a whole of the sealing device is lowered, it is possible to contribute to an improvement in the specific fuel consumption.

Further, since the inner diameter section 16a of the dust filter 16 is brought into close contact with the outer peripheral surface of the sleeve 21 of the slinger 2 with the suitable fastening margin, even in the edge portion 16c of the deepest section in the cutouts 16b, a gap is not generated with respect to the outer peripheral surface of the sleeve 21 by the cutouts 16b, and the dust filter 16 is not made thin for lowering the torque. Accordingly, a desired dust sealing property can be secured.

Further, since the protrusion 23 and the inner diameter section 16a of the dust filter 16 are opposed to each other in the axial direction in a state in which they can be engaged with each other, once the protrusion 23 formed at the end portion of the sleeve 21 passes through the inner diameter section 16a while suitably pushing open the inner diameter section 16a of the dust filter 16, by inserting the sleeve 21 of the slinger 2 to the inner periphery of the seal main body 1, from the separated state shown in FIG. 2, it is possible to temporarily assemble the seal main body 1 and the slinger 2 in a come-off preventing state. Further, in accordance with the present invention, since it is not necessary to make the dust filter 16 thin for lowering the torque as mentioned, it is possible to secure a desired engaging force with the protrusion 23 by the inner diameter section 16a of the dust filter 16 which is brought into close contact with the outer peripheral surface of the sleeve 21 with the suitable [symbol] fastening margin, and it is possible to prevent the seal main body 1 and the slinger 2 from being separated, for example, in a transporting process in a temporary assembled state.

In this case, in the embodiment mentioned above, the structure is made such that the seal lip 12 and the dust filter 16 are slidably brought into close contact with the slinger 2 serving as the rotation-side member, however, the present invention can be applied to a structure in which the seal lip 12 and the dust filter 16 are slidably brought into close contact with the outer peripheral surface of the rotating shaft 300 serving as the rotation-side member, and the material of the seal lip 12 or the like is not particularly limited.

Further, a shape of the cutout 16b can be considered to be a semicircular shape, a U-shaped form, a V-shaped form, a wave form and the like in addition to the C-shaped form in section as illustrated, and is not particularly limited.

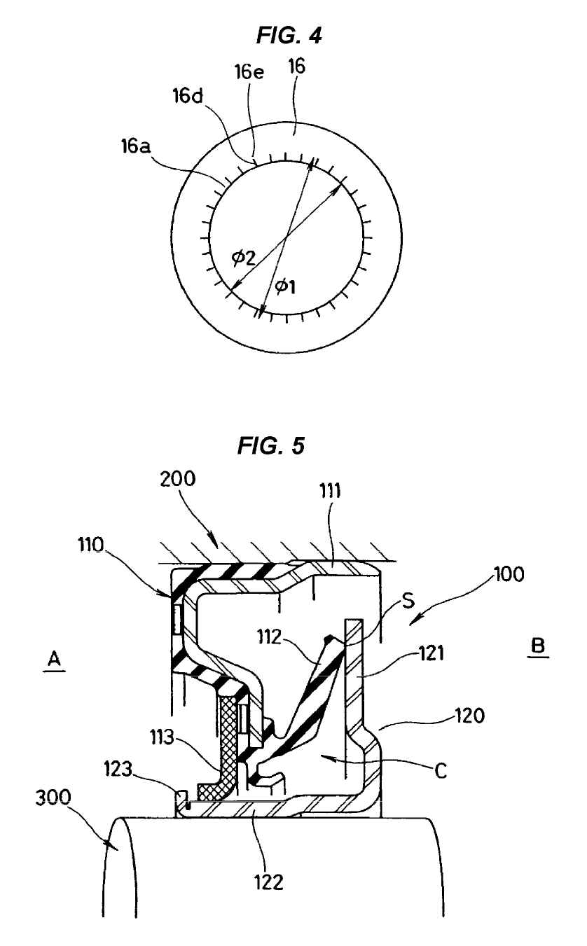

FIG. 4 is a half cross sectional view in a installed state showing a sealing device in accordance with a second embodiment of the present invention by being cut along a plane passing through an axis.

The second embodiment is structured such that a plurality of slits 16d extending in a radial direction are formed at a predetermined circumferential interval, in place of a plurality of cutouts 16b in the first embodiment described previously, in the inner diameter section 16a of the dust filter 16. Further, the dust filter 16 is formed as a plane which is orthogonal to an axis in an uninstalled state, and an inner diameter φ1 of a deepest section of each of the slits 16d is larger than an inner diameter φ2 of the dust filter 16, and is slightly smaller than an outer diameter φ3 (refer to FIG. 2) of the sliding portion with the dust filter 16 in the sleeve 21 of the slinger 2, in this state. The other structures are the same as those of the first embodiment described previously.

Accordingly, even in this state, since the inner diameter section 16a of the dust filter 16 is brought into close contact with the outer peripheral surface of the sleeve 21 shown in FIG. 1 in a state of being suitably pushed open, and an edge portion 16e of the deepest section in each of the slits 16d is brought into close contact with the outer peripheral surface of the sleeve 21 with a suitable fastening margin, the same effects as those of the first embodiment can be achieved.

1. A sealing device comprising:
a seal lip attached to a non-rotating housing and slidably brought into close contact with a rotation-side member; and
a dust filter located closer to an atmosphere side than the seal lip and having an inner diameter section slidably brought into close contact with an outer peripheral surface of said rotation-side member,
wherein a plurality of cutouts are formed in the inner diameter section of said dust filter at a predetermined circumferential interval, and an edge portion of a deepest section in each of said cutouts is in close contact with the outer peripheral surface of said rotation-side member with a suitable fastening margin.

2. A sealing device comprising:
a seal lip attached to a non-rotating housing and slidably brought into close contact with a rotation-side member; and
a dust filter located closer to an atmosphere side than the seal lip and having an inner diameter section slidably brought into close contact with an outer peripheral surface of said rotation-side member,
wherein a plurality of slits are formed in the inner diameter section of said dust filter at a predetermined circumferential interval, and an edge portion of a deepest section in each of said slits is in close contact with the outer peripheral surface of said rotation-side member with a suitable fastening margin.
